(19) United States
(12) Patent Application Publication
(10) Pub. No.: US 2003/0151326 A1
(43) Pub. Date: Aug. 14, 2003

(54) Stator for an axial flux electrical machine

(76) Inventors: Ahsan Aminul, Heston (GB); Keith Robert Pullen, Lundon (GB); Ross Waring, Kingston-upon Thames (GB)

Correspondence Address: Gottlieb Rackman & Reisman, 270 Madison Avenue, New York, NY, 10016-0601, US

(21) Appl. No.: 10/182,856

(22) PCT Filed: Feb. 5, 2001
(86) PCT No.: PCT/GB01/00451

(30) Foreign Application Priority Data
Feb. 4, 2000 (GB) 0002647.6

(51) Int. Cl. H02K 9/00; H02K 1/06

(52) U.S. Cl. 310/217; 310/58

(57) ABSTRACT

The present invention provides an improved stator for an axial flux electrical machine in which the stator discs which contain the windings of the stator are spaced apart by spot spacers to provide improved quantity and control of the cooling fluids passing though the stator. The present invention further provides improved control of the flow of cooling fluids through the stator by controlling the points at which the cooling fluid enters and exits the space between the stator discs.

The present invention relates to the construction of stators for axial flux electrical machines.

The construction of axial flux machines is well known. Axial flux machines generally comprise a rotor on a shaft, the rotor having one or more discs mounted thereon, the discs comprising a number of magnets. The stator of the electrical machine is arranged to have one or more stator discs comprising electrical windings. These stator discs are arranged to radially overlap with the rotor discs. When the stator windings are energised, in the case of a motor an axial field is developed causing the magnets in the rotor disc to be repelled in a specific direction. This causes the rotor shaft to turn. Similarly, by mechanically driving the rotor shaft, the movement of the magnets in the rotor discs produces a field which generates an electrical current in the windings of the stator discs to provide electricity. Previously, such electrical machines have been constructed having stators with two or more discs, in which the electrical coils are situated, spaced apart, so as to define a space therebetween, using spacers. These spacers allow cooling air or fluid to pass between the discs to cool the coils, or windings. The spacers are chosen according to their physical and mechanical properties and are generally in the shape of long thin wedges or long continuous arcs.

The present invention has, however, identified that the design and arrangement of the spacers used in the prior art machine can lead to thermal hot spots due to the pattern of flow of cooling fluid over the disc and also due to the spacers themselves actually covering parts of the disc, thus preventing heat from being removed from those parts effectively. The inventors of the present invention, having realised this, have developed a modified stator in accordance with the present invention.

Therefore, according to the present invention there is provided a stator for an axial flux electrical machine, the stator having one or more stator disc units comprising a plurality of stator discs having a plurality of spot spacers therebetween.

The present invention also provides an axial flux electrical machine comprising such a stator.

The present invention utilises “spot” spacers or supports to give increased cooling since turbulence in the cooling fluid is increased, thermal hot spots are minimised and less surface area of the heat generating parts (i.e. the electrical windings) is covered. Throughout this specification, the term “spot spacers” is used to refer to spacers having a cross sectional area which is significantly smaller than the area of the discs which the spacers are mounted between. For example, for a typical stator of around 110 mm in diameter the spots would preferably have dimensions of the order of a few millimetres, more preferably about 1%-3% of the stator diameter.

The spot spacers may have any cross sectional shape. However, their shape is preferably chosen according to the application or construction of the electrical machine. For example, for low cost, the spot spacers are preferably circular in cross sectional shape. The stators may have a tear-drop shape aligned with the flow direction to reduce pressure losses along the path of the cooling fluid flow. A reduction in the pressure loss in the cooling fluid flow through the passages will increase the overall electrical machine efficiency since coolant pumping power, usually extracted from the rotor of the machine, is reduced. The shape of the spot spacer may also be chosen to enhance the turbulence of the flow of cooling fluid through the machine to increase heat transfer. This allows the machine to be rated for high power.

Furthermore, the shape and size of the spot supports may be the same as each other or different depending upon requirements.

The use of spot supports in some cases allows the same support layout to be used on different cooling configurations. This flexibility helps to reduce overall cost and complexity of manufacture by standardising components.

The present invention will now be described by way of example with reference to the following drawings in which:

FIG. 1 shows examples of the shapes which the spot spacers may have;

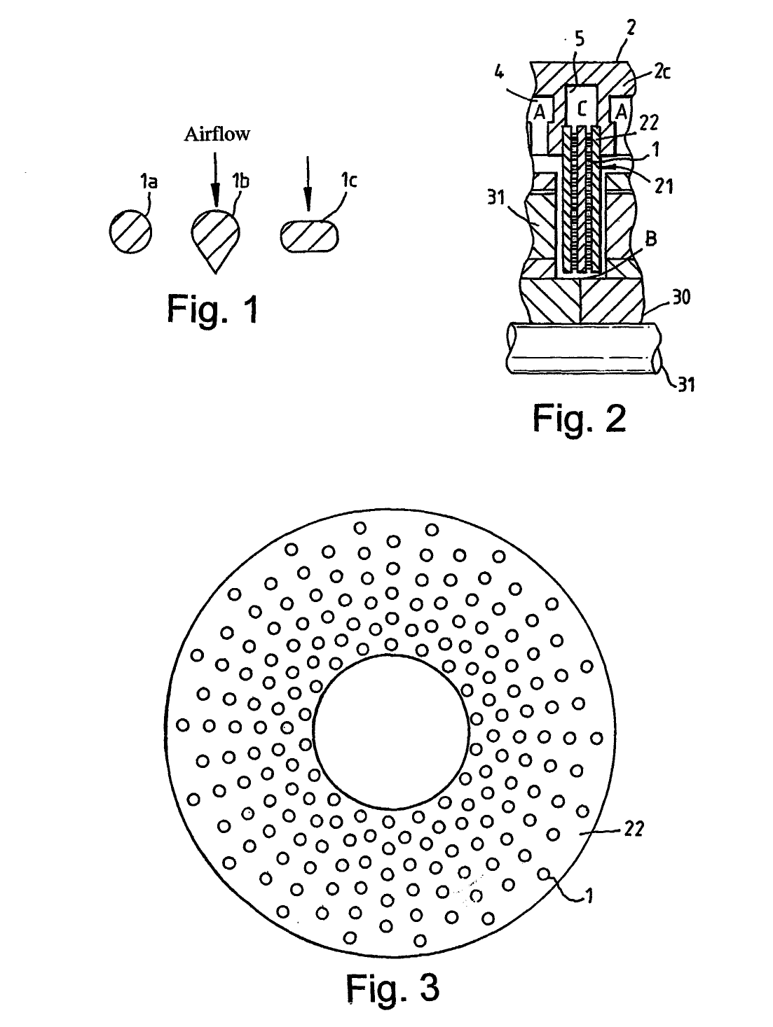

FIG. 2 shows a longitudinal cross-section through a part of a machine in accordance with the present invention;

FIG. 3 shows a transverse cross-section through a stator disc unit according to the present invention;

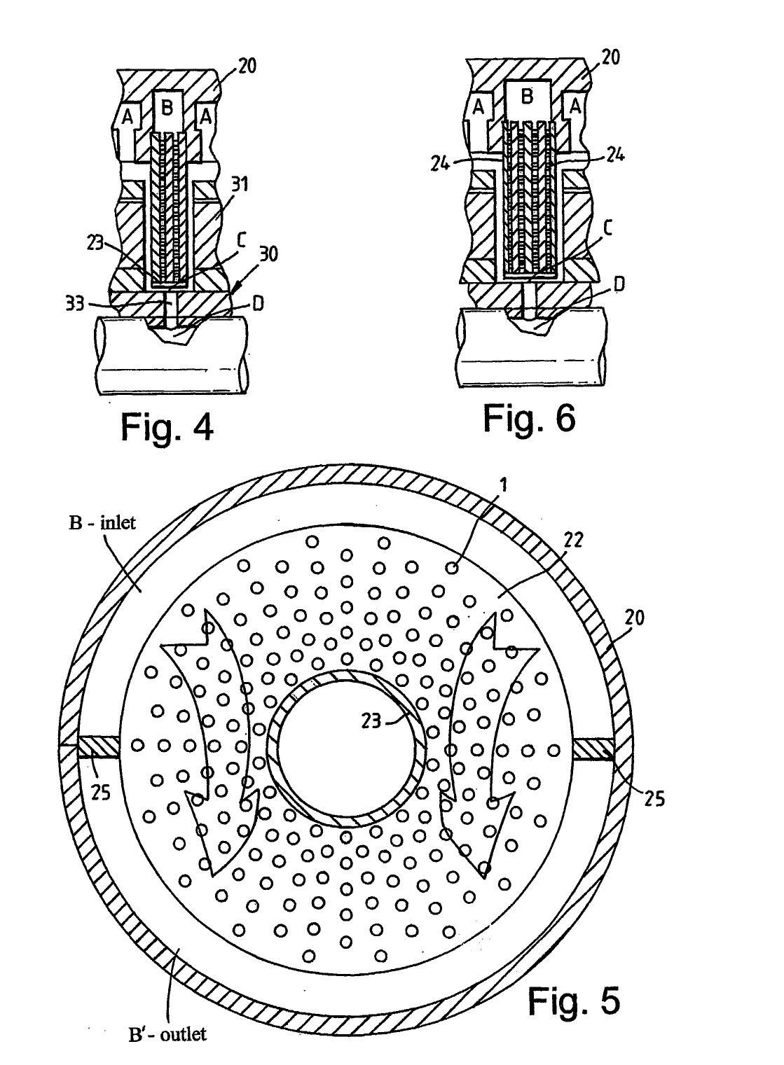

FIG. 4 shows a partial longitudinal cross-section of an alternative embodiment of the present invention;

FIG. 5 shows a cross-section through a machine according to an embodiment of FIG. 4;

FIG. 6 shows a partial longitudinal cross-section through a machine in accordance with a third embodiment of the present invention;

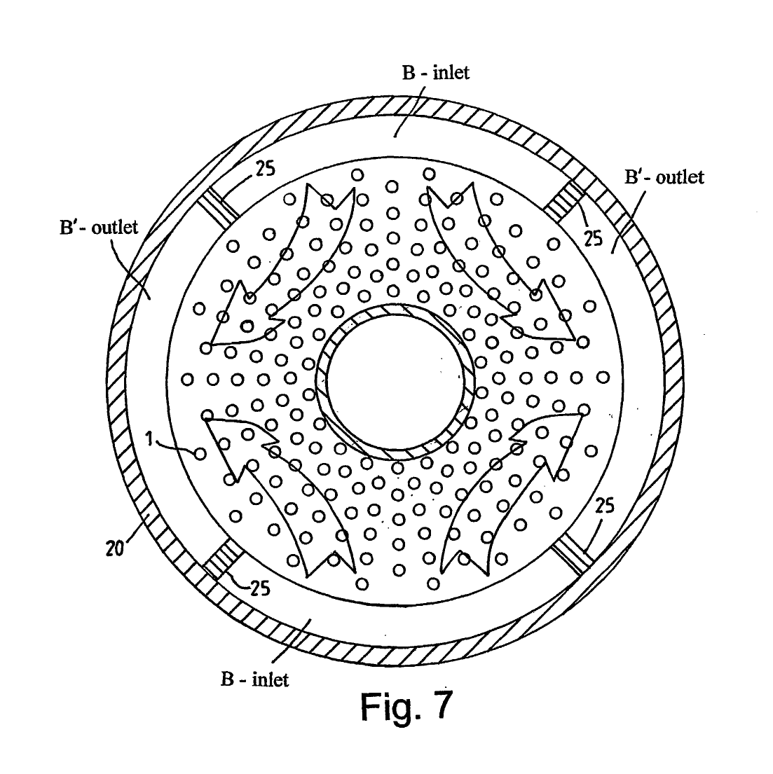

FIG. 7 shows a cross-section through a motor in accordance with a fourth embodiment of the present invention;

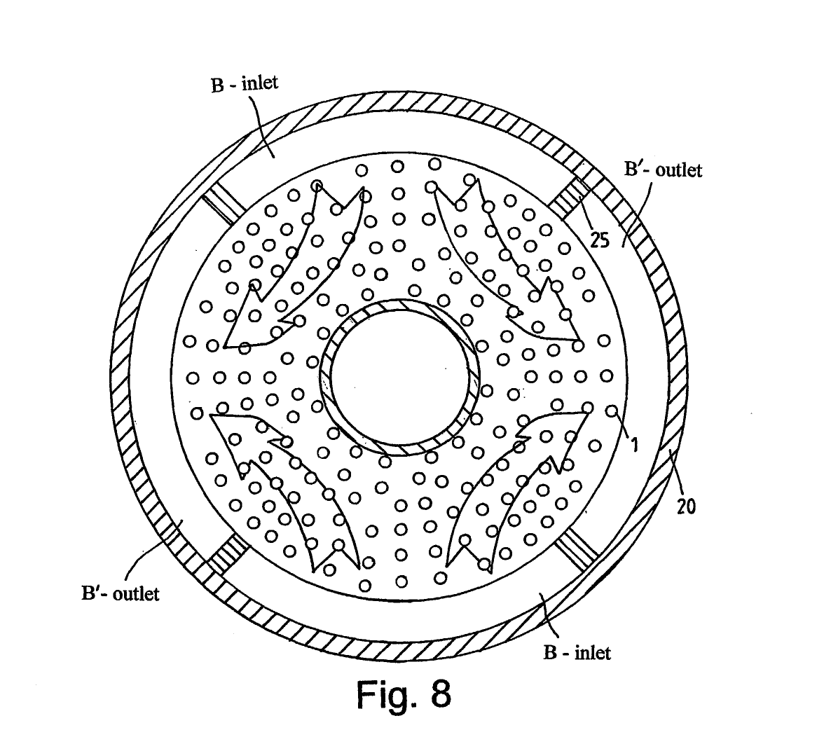

FIG. 8 shows a cross-section through a motor according to a fifth embodiment of the present invention; and

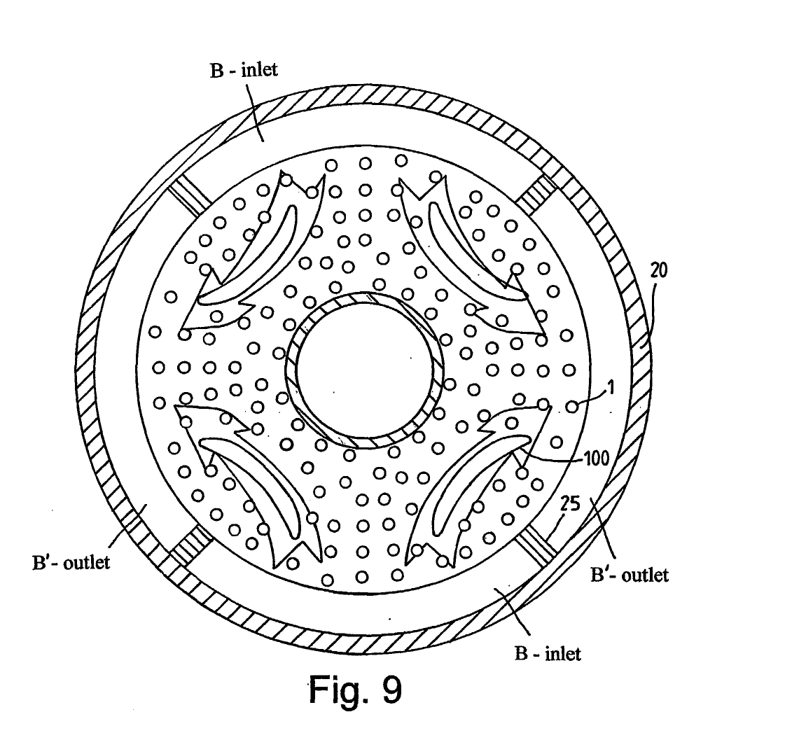

FIG. 9 shows a cross-section through a machine according to a sixth embodiment of the present invention.

FIG. 2 shows a cross-section through one stage of a stator 2 between two magnetic rotor discs 31 of an axial machine according to the present invention. The stator stage includes a stator disc unit 21 comprising, in this case, three stator discs 22. The number of stator stages in a machine and the number of stator discs in a stator disc unit is not restricted to the example shown here and may be varied according to the function of the machine. As can be seen in FIG. 2, two spaces are defined between the three stator discs 22. These spaces are provided by a plurality of spot spacers 1 (shown in FIG. 3).

The spot spacers are distributed across the surface of the stator disc 22 to provide good support between the stator discs 22 whilst providing improved flow of cooling fluid across the surface of the stator discs 22. This provides good structural integrity to the stator disc unit 21 whilst providing improved efficiency of cooling. Also, by minimising the pressure losses in the pathway of the cooling fluid, improved overall efficiency of the electrical machine can be achieved.

In the construction shown in FIG. 2, cooling fluid, which may be gas or liquid, is supplied to chamber A. The gas passes into the circumferential gap between the rotor discs 31 and the stator body 20 and then down the gaps between the stator disc unit 21 and the rotor disc 31. As the gas passes in a generally radially inward direction, the gas will tend to be swirled by the action of the rotors such that the gas is given a tangential component of velocity as it enters the region B. The gas then enters the passages between the stator discs 21 at a significant angle to the radial direction. If the spacers were radial or inclined strip or wedge shaped, high pressure losses would result unless these long spacers were aligned closely with the angle of flow velocity. However, if spot spacers are used, this is no longer the case and the new design can accommodate any angle of flow velocity without high pressure losses. The gas passes through the stator disc unit and exits into chamber C, having extracted heat. The heated gas then passes out of this part of the machine.

Whilst in the above construction, the gas is indicated as travelling from chamber A to chamber C via chamber B, the cooling fluid may equally be passed from chamber C to chamber A via chamber B. This is simply achieved by arranging the appropriate pressure difference between the two chambers. In both cases cooling is enhanced due to lower shielding of the heat generating parts of the stator.

In an alternative embodiment of the present invention, shown in FIGS. 4 and 5, two separate pathways are provided for the cooling fluid. Referring to FIG. 4, cooling fluid enters a hollow chamber D in the rotor shaft 32 and exits into chamber C through passages 33 in the rotor body 30. The passages in the rotor body 30 may be radial or inclined. The stator disc unit 21 is separated from chamber C by a ring 23. The inner circumference of the stator disc unit 21 is closed by the ring. The cooling fluid thus passes around the stator disc unit 21 and up between it and the rotor discs 31 and into chamber A. Again, the direction of flow of cooling fluid is not essential to the invention and the cooling fluid could be arranged to flow in the opposite direction.

The second cooling pathway provides cooling fluid to a two-part chamber in the stator body 20. The chamber is annular and arranged around the outer circumferential periphery of the stator disc unit. This chamber is divided by separators 25 arranged on opposite sides of the stator to provide two separate chambers B and B′. In FIGS. 4 and 5, it can be seen that chamber B is arranged around half of the circumference of the stator disc unit 21 and a second chamber B′ is arranged around the opposite half of the circumference of the stator disc unit. In this way, cooling fluid is provided into chamber B which then passes into the spaces between the stator discs 22, passing around the spot spacers 1 therein, and then exits generally radially out of the stator disc unit 22 into chamber B′. The cooling fluid passes from chamber B to chamber B′ as shown by the arrows in FIG. 5.

By providing two separate cooling paths, the outer and inner surfaces of the stator disc unit 21 are cooled by separate cooling fluid flow allowing more heat to be extracted and thus allowing the machine to be rated at a higher power.

FIG. 7 shows a further modification of the construction shown in FIGS. 4 and 5. In this construction, rather than dividing the chamber into two halves (B and B′), the circumference of the stator disc unit 21 is divided into four separate chambers by four separators 25. Each separator defining 90°, or thereabouts, of the circumference of the stator disc unit. In this way, opposite pairs of chambers are used to provide the inlet and outlet respectively of the cooling fluid through the stator disc unit. As is shown in FIG. 7, cooling gas is input through the chambers at the top and bottom of the figure (B-inlet) and passes through the spaces between the stator discs in the directions shown by the large arrows in FIG. 7 to pass out through the outlet chambers (B′-outlet) which are arranged at the left and right sides of the view of FIG. 7. This construction provides further advantages over the construction shown in FIGS. 4 and 5 since the pressure required to drive a given cooling fluid flow will be reduced. This means that less energy is required to drive the cooling fluid and thus less energy is extracted from the rotor. Thus more useful power is output from the machine resulting in improved overall efficiency of the electrical machine. Alternatively, because the pressure required to drive a given flow is less, by maintaining the same pressure difference, a greater cooling fluid flow can be obtained resulting in greater cooling of the stators and a higher electrical power rating of the machine.

FIG. 6 shows a further variation of the system shown in FIGS. 4, 5 and 7. In this embodiment, two additional passages are formed on the stator by adding disc-shaped cover plates 24 which are separated from the outer stator discs 22 by means of spot spacers 1. These additional passages provide better cooling of the outer surfaces of the stator discs. Better cooling results because the cooling fluid will be at a lower temperature than the cooling fluid flowing from chamber C to A, in the embodiment of FIGS. 4, 5 and 7, which will have been heated due to windage as is the case in the construction shown in FIG. 4. The design of the spot supports between the cover plates 24 and the outermost stator discs may be the same as those between the stator discs 22 themselves although this is not essential. Furthermore, the actual width of the passages between the coverplates 24 and the outermost stator discs 22 may be the same width as the passages between the stator discs themselves but again this is not essential.

In the previously described constructions, the spot spacers have been shown regularly arranged around the axis of the stator. However, it may be desirable to vary the spacing of the spot spacers as shown in FIG. 8. FIG. 8 is otherwise the same as the construction shown in FIG. 7 but the concept is equally applicable to other constructions such as those previously described. By varying the spacing of the spot spacers, the flow of cooling fluid through the spaces between the stator discs can be varied. One reason for doing this is to increase the flow resistance in certain regions and reduce it in others so as to obtain a more even flow within the passage. For example, it may be desirable to modify the spacing such that the flow is greater in those regions where there is a longer flow path of the cooling fluid. If the cooling fluid path is longer, the coolant spends more time being heated and so the coolant is less effective at removing heat or more coolant is required to prevent the coolant and also the part of the machine being cooled exceeding a particular temperature. By causing the coolant to flow more rapidly through some parts, the amount of coolant passing a particular point can be increased and thus even though the path length is longer, the coolant and machine do not overheat, whilst still maintaining effective cooling.

FIG. 9 shows a further modification which shows a modification of the construction shown in FIG. 8 but is equally applicable to the other constructions. In FIG. 9, additional supports 100 are added in addition to the spot spacers 1. Again, these additional spacers can be used to obtain a desirable flow pattern for the cooling fluid either in combination with or instead of modifying the layout of the spot spacers. Again, this can be used to provide more effective control of the flow of cooling fluid through the stator disc unit, this allowing the machine to have a greater electrical power rating.

In the previously described construction, the spot spacers are shown as being substantially circular, and also all the same size. From the point of manufacturing, this arrangement is very convenient. However, in terms of the properties of the machine into which the stator discs are incorporated, it may be more desirable to modify the shape and sizes of the spot spacers. By using tear-drop shaped spacers aligned along the direction of flow of the cooling fluid, the pressure losses as the cooling fluid passes around the spacers can be reduced. As indicated above, this reduction in the pressure loss as the cooling fluid passes through the stator disc unit allows either greater efficiency or a higher power rating to be obtained.

FIG. 1 shows three examples of shapes which may be used in the construction in accordance with the present invention. The third generally rectangular shape of spot spacer causes high turbulence in the flow path of the cooling fluid. This turbulence ensures thorough mixing of the cooling fluid and hence improved heat transfer from the stator disc to the cooling fluid. Again, this clearly has advantages in tenns of the maximum rating or maximum efficiency of the machine.

1. A stator (2) for an axial flux electrical machine, the stator having one or more stator disc units (21) comprising:
a plurality of stator discs (22) having a plurality of spot spacers (1) therebetween.

2. A stator according to claim 1, wherein the spot spacers are circular.

3. A stator according to claim 1, wherein the spot spacers are tear-drop shaped.

4. A stator according to claim 1, wherein the spot spacers are generally rectangular.

5. A stator according to any one of the preceding claims, wherein the spacers are uniformly arranged around the axis of the stator disc.

6. A stator according to claim 5, wherein the spacers are arranged in radially extending rows.

7. A stator according to claim 6, wherein the adjacent rows of spacers are radially offset.

8. A stator according to any one of claims 1 to 4 wherein the spacers are irregularly arranged.

9. A stator according to claim 8, wherein the concentration of spacers in a given area is selected according to the desired flow of cooling fluid in that area.

10. A stator according to claim 9, wherein the desired flow of cooling fluid is selected according to the path length of the cooling fluid through the space between the stator discs.

11. A stator according to any one of the preceding claims, wherein each stator disc unit also comprises one or more additional spacers (100), having a different shape to the spot spacers (1), between said stator discs.

12. An axial flux electrical machine comprising a stator according to any one of the preceding claims.

13. An axial flux electrical machine comprising:
a rotor (30) having one or more rotor discs (31), and a stator (2) having one or more stator disc units (21), each stator disc unit comprising a plurality of stator discs (22), wherein
a cooling fluid passageway is defined which includes a portion which passes through the or each space between the stator discs, and a further portion which passes between the stator disc unit (21) and the or each adjacent rotor disc (31).

14. An axial flux electrical machine comprising:
a rotor (30) having one or more rotor discs (31), and a stator (2) having one or more stator disc units (21), each stator disc unit comprising a plurality of stator discs (22), having:
a first cooling fluid passageway which includes a first portion which passes from a hollow interior of the rotor (30), radially through one or more passages in the rotor into the space between the inner circumference of the stator disc unit and the or each rotor and a second portion which passes between the stator disc unit (21) and the or each adjacent rotor disc (31); and
a second cooling fluid passageway lying between adjacent stator discs and having at one or more inlets and one or more outlets on the circumference of the stator disc unit, such that, in use, cooling fluid enters the second cooling fluid passageway through an inlet and out again through an outlet.

15. A machine according to claim 14, wherein the stator disc unit has a single inlet and a single outlet arranged circumferentially on opposite halves of the stator disc unit.

16. A machine according to claim 14, wherein the stator disc unit comprises a plurality of inlets and a plurality of outlets which are regularly arranged around the circumference of the stator disc unit with each inlet or outlet being arranged between a pair of adjacent outlets or inlets respectively.

17. A stator for an electrical machine, substantially as described herein with reference to the accompanying drawings.

18. An axial electrical machine substantially as described herein with reference to the accompanying drawings.
